(19) United States
(12) Patent Application Publication
(10) Pub. No.: US 2008/0314274 A1
(43) Pub. Date: Dec. 25, 2008

(54) METHOD AND APPARATUS FOR UNLOADING PRINTING PLATES

(76) Inventor: Calvin D. Cummings, Surrey (CA)

Correspondence Address: David A. Novais,;Patent Legal Staff, Eastman Kodak Company, 343 State Street, Rochester, NY, 14650-2201, US

(21) Appl. No.: 11/764,943

(22) Filed: Jun. 19, 2007

(51) Int. Cl. B41L 49/00; B65G 60/00

(52) U.S. Cl. 101/480; 414/788.8

(57) ABSTRACT

An unload table (50) for a plate making machine comprises an unload table proximal segment (194) proximate the cylindrical surface (120) of the imaging drum (110) of the plate making machine. The unload table proximal segment can tilt to receive a printing plate (40) being unloaded from the imaging drum. In a further embodiment the unload table itself can also tilt about another axis, allowing the unload table and unload table proximal segment to remain clear of any fixtures on the rotating imaging drum, thereby allowing a printing plate imaged on the imaging drum while the unload table and unload table proximal segment are moving in to a unloading orientation. This enhances the throughput of the plate making machine by reducing the total time required for bulky unload tables to reposition and re-orient for unloading of printing plates.

### FIELD OF THE INVENTION

The invention relates to printing and in particular, to unloading imaged printing plates from a plate making machine.

### BACKGROUND OF THE INVENTION

Imagesetters and platesetters are plate making machines employed to expose the substrates that are used in offset printing systems. Imagesetters are typically used to expose the film that is then used to expose and make the plates for the printing system. Platesetters are used to directly expose the plates, typically using arrays of digitally controlled lasers.

In the case of platesetters, the plates are typically large substrates coated with photosensitive or thermally-sensitive emulsion layers. For large run applications, the plates are typically fabricated from aluminum, though plates made from other materials are also available for smaller runs.

Platesetters of the computer-to-plate variety are used to render digitally stored print image content onto these printing plates. Typically, a computer system is used to drive an imaging engine of the platesetter. The imaging engine selectively exposes the emulsion on the plates. In present generation machines this operation is typically performed using digitally controlled laser arrays. After this exposure, the emulsion is developed and either the exposed or the unexposed emulsion is removed, thereby producing a printing master. During the printing process, ink will selectively adhere to the surface of the plate in either the exposed or the unexposed areas to transfer the inked image to a print medium.

Platesetters typically operate in commercial environments where throughput is a critical parameter. This throughput is often used as the criteria for selecting between the various commercially available systems and is largely determined by the cycle time required: to load the substrate into the imaging engine; for the scanner of the imaging engine to expose the substrate; and to unload the substrate. Most conventional systems expose the media by scanning. In a common implementation, the plate or film media is fixed to the outside or inside of a drum and then scanned with a laser source in a raster fashion. The laser's dot is moved longitudinally parallel to the axis of the drum in what is known as the “subscan direction,” while the drum is rotated under the imaging dot, thereby moving the exposing beam in the “mainscan direction.” As a result, by modulating the laser, the substrate is selectively exposed in a continuous helical scan.

The typical approach to reducing the cycle time of the imaging engine focuses on decreasing the time required for the scanner of the imaging engine to expose the substrate. Some have approached this problem by increasing the speed at which the lasers are modulated, enabling the drum to be rotated at a higher rate. There are limitations, however, in the power of the laser and its speed of modulation. The plate emulsion also imposes limitations of total required exposure, energy or heat. Other solutions use spatial light modulators or laser arrays, so that multiple lines of the image can be exposed in each rotation of the drum.

An alternative path to decreasing cycle time involves loading multiple substrates simultaneously on the drum. In one example, a number of substrates are positioned along the drum's axis. In still another approach, multiple substrates are loaded around the circumference of the drum. This, however, tends to have a limited impact on cycle time. The exposure step is consequently longer, since more substrate surface area must now be exposed.

These approaches, however, address only one of the three throughput factors described above. In U.S. Pat. No. 6,722,280 (Shih et al.) a system is described for loading and unloading plates to and from an imaging drum simultaneously. However, for very large plates this arrangement is problematical and arrangements are preferred in which both the load and unload tables are horizontal, since a horizontal configuration is preferred for transport of large plates.

While considerable effort has gone into devising auto-loading and auto-unloading systems for printing plates, the time taken to load and/or unload an individual plate remains problematical and is still a fundamental limitation to throughput in platesetters in the computer-to-plate environment.

### SUMMARY OF THE INVENTION

Briefly, according to one aspect of the present invention, a method for unloading a printing plate from a cylindrical surface of an imaging drum onto an unload table is shown, wherein the unload table comprises an unload table proximal segment. The method comprising positioning a first end of the printing plate proximate the unload table proximal segment by rotating the imaging drum about a cylindrical axis; orienting the unload table proximal segment close to and substantially tangential to the cylindrical surface by rotating the segment about a first axis in a first direction; and moving the printing plate onto the unload table proximal segment by rotating the imaging drum about a cylindrical axis.

In some embodiments of the invention the method further comprises tilting of the unload table proximal segment to a clearance orientation and tilting the unload table itself to an unloading orientation about a second axis. These tilting actions may be performed in sequence or simultaneously.

In a further aspect the invention, a method for unloading a printing plate from a cylindrical surface of an imaging drum onto an unload table is described. The unload table comprises an unload table proximal segment. The method comprising tilting of the unload table to an unloading orientation while imaging the printing plate. Yet another embodiment comprises tilting the unload table proximal segment to a clearance orientation before or during the tilting of the unload table to an unloading orientation. This embodiment can further comprise positioning a first end of the printing plate proximate the unload table proximal segment by rotating the imaging drum about a cylindrical axis; orienting the unload table proximal segment close to and substantially tangential to the cylindrical surface by rotating the unload table proximal segment about a first axis in a first direction; and moving the printing plate onto the unload table proximal segment by rotating the imaging drum about a cylindrical axis.

In a further aspect the invention constitutes an unload table for unloading a printing plate from an imaging drum, the imaging drum having a cylindrical surface and the unload table comprising an unload table proximal segment proximate the cylindrical surface, the unload table proximal segment configured to be oriented close to and substantially tangential to the cylindrical surface by being swiveled with respect to the unload table about a first axis. The unload table is configured to be tilted to an unloading orientation about a second axis and the unload table proximal segment is capable of being placed in a clearance orientation. The unload table can be configured to be tilted to an unloading orientation about a second axis and the unload table proximal segment can be configured to be tilted to a clearance orientation before the unload table is tilted to an unloading orientation. In another embodiment of the present invention the unload table proximal segment is configured to be tilted to a clearance orientation while the unload table is being tilted to an unloading orientation.

In yet a further aspect the invention constitutes an unload table for unloading a printing plate from an imaging drum, the unload table comprising an unload table proximal segment, the unload table capable of being placed in an unloading orientation while the printing plate is being imaged. The unload table proximal segment can be configured to tilt to a clearance orientation before or during tilting of the unload table to an unloading orientation.

### BRIEF DESCRIPTION OF THE DRAWINGS

In the drawings which illustrate non-limiting embodiments of the invention:

FIG. 1 a is a schematic diagram of a prior art external drum-type plate making machine served by an unload table shown in the horizontal position;

FIG. 1b is a schematic diagram of a prior art external drum-type plate making machine served by an unload table shown in the tilted position;

FIG. 2a shows an external drum-type plate making machine with its unload table in a non-unloading configuration;

FIG. 2b shows an external drum-type plate making machine with its unload table in an unloading configuration; and

FIG. 3 is a flow chart according to a method of the present invention;

FIG. 4a shows the orientation of unload table and unload table proximal segment while printing plate is being imaged or loaded on imaging drum;

FIG. 4b shows unload table and unload table proximal segment in an orientation in which unload table is rotated about unload table tilt axis in unload table rotation direction to position the proximal end of unload table in an orientation in which the proximal end of unload table is close to cylindrical surface;

FIG. 4c shows unload table and unload table proximal segment in an orientation in which printing plate is being unloaded from cylindrical surface of imaging drum; and

FIG. 5 is a flow chart of another embodiment of the method according to the present invention.

### DETAILED DESCRIPTION OF THE INVENTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

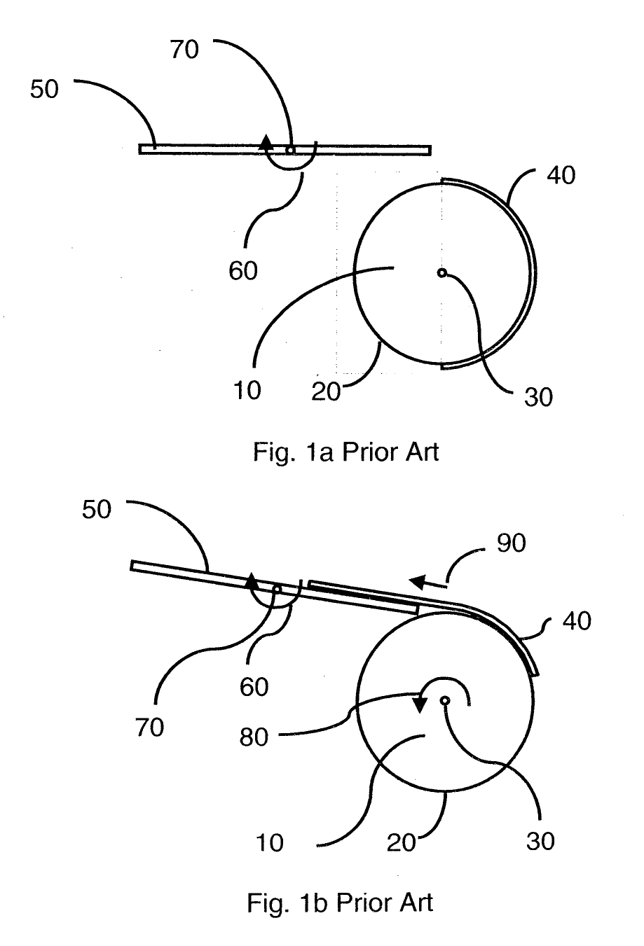

In FIG. 1 a an imaging drum 10 of a plate making machine has a cylindrical surface 20 and can be rotated about its cylindrical axis 30. At least one printing plate 40 may be located on cylindrical surface 20 of imaging drum 10. Unload table 50 of the plate making machine has a proximal end proximate cylindrical surface 20 of imaging drum 10, and a distal end, distal from cylindrical surface 20 of imaging drum 10. The clearance between the proximal end of unload table 50 and cylindrical surface 20 is of such magnitude as to allow any clamps (not shown) holding printing plate 40 to cylindrical surface 20 to move past the proximal end of unload table 50 when imaging drum 10 rotates about cylindrical axis 30. Given that there needs to be a load table (not shown) to supply printing plates to imaging drum 10, and that such a load table also has requirements of proximity to and clearance with respect to cylindrical surface 20, unload table 50 is capable of being rotated in unload table rotation direction 60 about unload table tilt axis 70. FIG. 1 a describes the orientation of the unload table while printing plate 40 is being imaged or loaded on imaging drum 10. In the present specification, the term “starting orientation” is used to describe this orientation of unload table 50.

FIG. 1b shows the prior art apparatus of FIG. I a when printing plate 40 is unloaded from imaging drum 10. To facilitate the unloading, the plate clamps proximate to the proximal end of unload table 50 are opened to release a first end of printing plate 40. As a result, the first end of printing plate 40 is raised off cylindrical surface 20 due to the elasticity of the plate. Unload table 50 is rotated about unload table tilt axis 70 in unload table rotation direction 60 to position the proximal end of unload table 50 in an orientation in which the proximal end of unload table 50 is close to and substantially tangential to cylindrical surface 20. The term “unloading orientation” is used to describe this orientation of unload table 50. When imaging drum 10 is subsequently rotated in direction 80 about cylindrical axis 30, printing plate 40 moves onto unload table 50 in direction 90. To complete the unloading process, the rotation of imaging drum 10 is maintained until a second end of printing plate 40 is proximate the proximal end of unload table, at which point the clamps holding the second end of printing plate 40 to cylindrical surface 20 are opened and the second end of printing plate 40 is released. A suitable transporting device (not shown) on unload table 50 then moves printing plate 40 further onto unload table 50, and unload table 50 rotates back about unload table tilt axis 70 to a starting orientation.

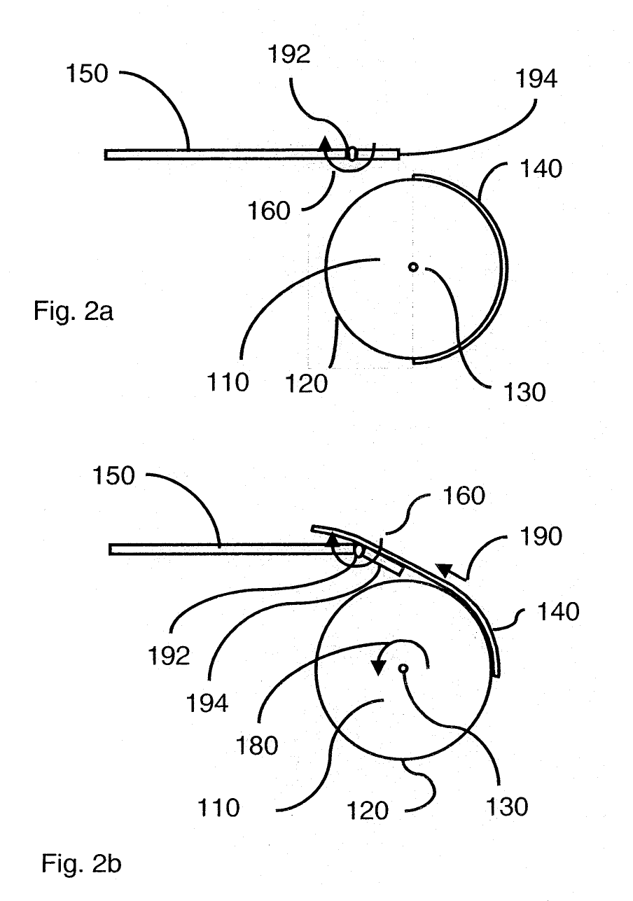

FIG. 2a shows a first embodiment of the apparatus and method of the present invention. An imaging drum 110 of a plate making machine has a cylindrical surface 120 and can be rotated about its cylindrical axis 130. At least one printing plate 140 may be located on cylindrical surface 120 of imaging drum 110. Unload table 150 of the plate making machine comprises an unload table proximal segment 194. Unload table proximal segment 194 has a proximal end proximate cylindrical surface 120 of imaging drum 110, and a distal end, distal from cylindrical surface 120 of imaging drum 110. Unload table proximal segment 194 is configured to be rotated about unload table proximal segment tilt axis 192.

FIG. 2a shows the orientation of unload table proximal segment 194 while printing plate 40 is being imaged or loaded on imaging drum 110. In the present specification, the term “starting orientation” is used to describe this orientation of unload table proximal segment 194. In this starting orientation, the clearance between the proximal end of unload table proximal segment 194 and cylindrical surface 120 is of such magnitude as to allow any clamps (not shown) holding printing plate 140 to cylindrical surface 120 to move past the proximal end of unload table 150 when imaging drum 110 rotates about cylindrical axis 130. Clearance is also required for any clamp actuator assemblies (not shown). Since large imaging plates can be very heavy and difficult to transport, a preferred orientation for unload table 150 is a horizontal orientation. The starting orientation for unload table proximal segment 194, shown as horizontal in FIG. 2a, can be any advantageous orientation that conforms to the clearance described above. However, it should be kept in mind that there may be a load table serving imaging drum 110 with printing plates and that such a load table also has requirements of clearance and proximity. Unload table proximal segment 194 therefore has to have a starting orientation that allows any load table present adequate clearance and proximity with respect to cylindrical surface 120.

FIG. 2b shows unload table proximal segment 194 in an orientation in which printing plate 140 is being unloaded from cylindrical surface 120 of imaging drum 110. In the present specification the term “unloading orientation” is used to describe such an orientation. To facilitate this unloading, the plate clamps proximate to the proximal end of unload table proximal segment 194 are opened to release a first end of printing plate 140. As a result, the first end of printing plate 140 is raised off cylindrical surface 120 due to the elasticity of the plate. Unload table proximal segment 194 is rotated about unload table proximal segment tilt axis 192 in unload table proximal segment rotation direction 160 to position the proximal end of unload table proximal segment 194 in an orientation in which the proximal end unload table proximal segment 194 is close to and substantially tangential to cylindrical surface 120. When imaging drum 110 is subsequently rotated in an imaging drum rotation direction 180 about cylindrical axis 130, printing plate 140 moves onto unload table proximal segment 194 in direction 190, and from there onto unload table 150, or onto a plate punching device (not shown). To complete the unloading process, the rotation of imaging drum 110 is maintained until a second end of printing plate 140 is proximate the proximal end of unload table proximal segment 194, at which point the clamps holding the second end of printing plate 140 to cylindrical surface 120 are opened and the second end of printing plate 140 is released. A suitable transporting device (not shown) on unload table 150 then moves printing plate 140 further onto unload table 150, or onto the plate punching device, and unload table proximal segment 194 rotates back about unload table tilt axis 192 to the starting orientation.

When unload table proximal segment 194 is in the unload orientation, the proximity of the proximal end of unload table proximal segment 194 to cylindrical surface 120, as well as the angular deviation of unload table proximal segment 194 from the tangent to surface 120 near the proximal end of unload table proximal segment 194 are both chosen such that printing plate 140 is raised above the surface of unload table proximal segment 194 when printing plate 140 is released as described here.

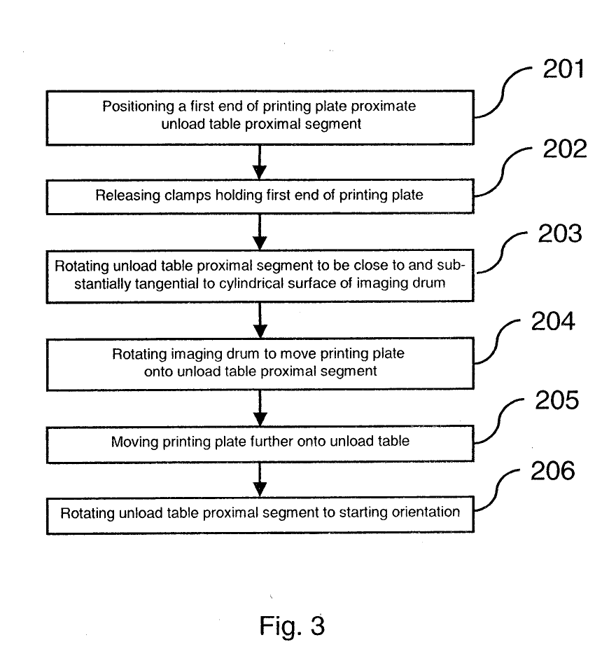

The method of use of this first embodiment of the present invention is described at the hand of FIG. 3 with reference to FIG. 2a and FIG. 2b. The method for unloading printing plate 140 from cylindrical surface 120 of imaging drum 110 comprises:
a) positioning (201) a first end of printing plate 140 proximate unload table proximal segment 194;
b) releasing (202) the clamps holding the first end of printing plate (140) to cylindrical surface 120, the first end of printing plate 140 thereby lifting off cylindrical surface 120 due to its own elasticity;
c) rotating (203) unload table proximal segment 194 around about unload table proximal segment tilt axis 192 in unload table proximal segment rotation direction 160 to position unload table proximal segment 194 in an orientation in which it is close to and substantially tangential to cylindrical surface 120;
d) rotating (204) imaging drum 110 about cylindrical axis 130 to move printing plate 140 onto unload table proximal segment 194 in direction 190 and from there onto unload table 150;
e) moving (205) printing plate 140 further onto unload table 150 using a suitable transporting device (not shown); and
f) rotating (206) unload table proximal segment 194 to the starting orientation about unload table tilt axis 192.

Further operations involving the rotating of imaging drum 110 may be imitated as soon as enough clearance has been established between the proximal end of unload table proximal segment 194 and cylindrical surface 120 of imaging drum 110.

The benefit of this first embodiment of the present invention is that the unload table proximal segment 294 weighs much less than the entire unload table 250. As a result it may be rotated faster, thereby improving throughput as compared with a solution involving the tilting of the entire unload table 50 as per the prior art.

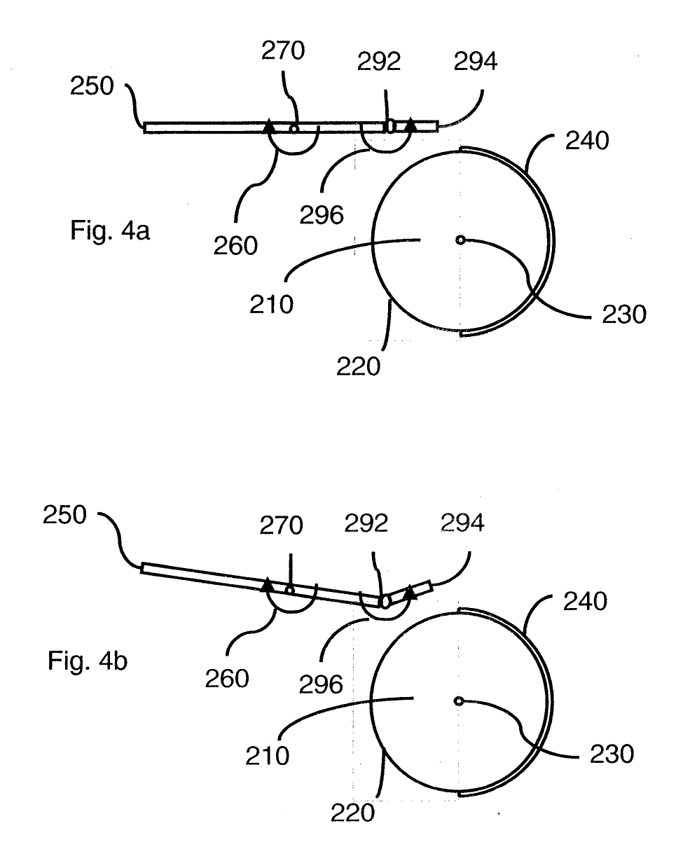

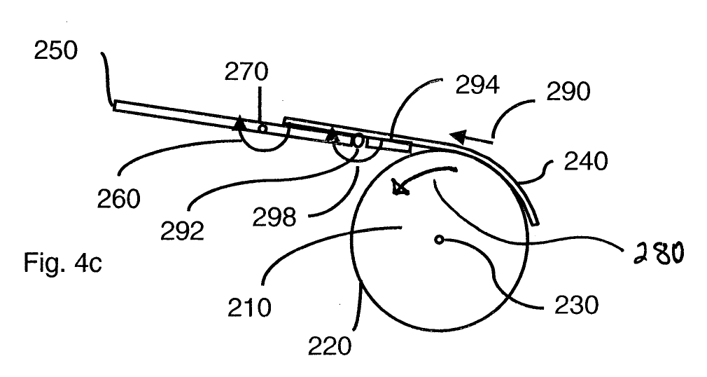

FIG. 4a shows a second embodiment of the apparatus and method of the present invention. An imaging drum 210 of a plate making machine has a cylindrical surface 220 and can be rotated about its cylindrical axis 230. At least one printing plate 240 may be located on cylindrical surface 220 of imaging drum 210. Unload table 250 of the plate making machine comprises an unload table proximal segment 294. Unload table proximal segment 294 has a proximal end proximate cylindrical surface 220 of imaging drum 210, and a distal end, distal from cylindrical surface 220 of imaging drum 210. Unload table 250 is configured to be rotated about unload table tilt axis 260 and unload table proximal segment 294 is configured to be rotated about unload table proximal segment tilt axis 292.

FIG. 4a shows the orientation of unload table 250 and unload table proximal segment 294 while printing plate 240 is being imaged or loaded on imaging drum 210. In the present specification, the term “starting orientation” is used to describe this orientation of unload table 250 and unload table proximal segment 294. In this starting orientation, the clearance between the proximal end of unload table proximal segment 294 and cylindrical surface 220 is of such magnitude as to allow any clamps (not shown) holding printing plate 240 to cylindrical surface 220 to move past the proximal end of unload table 250 when imaging drum 210 rotates about cylindrical axis 230. Clearance is also required for any clamp actuator assemblies (not shown). Since large imaging plates can be very heavy and difficult to transport, a preferred orientation for unload table 250 is a horizontal orientation. The starting orientation for unload table proximal segment 294, shown as horizontal in FIG. 2a, can be any advantageous orientation that conforms to the clearance described above. However, it should be kept in mind that there may be a load table serving imaging drum 210 with printing plates and that such a load table also has requirements of clearance and proximity. Unload table proximal segment 294 therefore has to have a starting orientation that allows any load table present adequate clearance and proximity with respect to cylindrical surface 220.

FIG. 4b shows unload table 250 and unload table proximal segment 294 in an orientation in which unload table 250 is rotated about unload table tilt axis 270 in unload table rotation direction 260 to position the proximal end of unload table 250 in an orientation in which the proximal end of unload table 250 is close to cylindrical surface 220. In FIG. 4b unload table 250 is shown as positioned substantially tangential to cylindrical surface 220. This is but one specific choice, and, in general, any other orientation advantageous to the unloading of printing plates from imaging drum 210 may be selected, subject to the requirements on unload table proximal segment 294 described below. The term “unloading orientation” is used to describe this orientation of unload table 250. Before or while unload table 250 is rotated into its unloading orientation, unload table proximal segment 294 is rotated about unload table proximal segment tilt axis 292 in a first unload table proximal segment rotation direction 296. The rotation of unload table 250 and unload table proximal segment 294 may be mutually independently controlled by a suitable controller, or may be linked such that, when unload table 250 is rotated in unload table rotation direction 260, unload table proximal segment 294 is automatically rotated about unload table proximal segment tilt axis 292 in first unload table proximal segment rotation direction 296. By rotating unload table proximal segment 294 in this fashion, adequate clearance is left between unload table proximal segment 294 and cylindrical surface 220 to allow any plate clamps present on cylindrical surface 220 to safely rotate past unload table proximal segment 294 if imaging drum 210 is rotated. This allows other processes involving the rotation of imaging drum 210 to continue while unload table 250 and unload table proximal segment 294 are being rotated as described in FIG. 4b. This enhances the throughput of the system, as the very heavy unload table 250, which is slow to rotate, is being pre-positioned for the unload process even as, for example, imaging of printing plate 240 is proceeding on imaging drum 210. By this approach unload table 250 finishes delivering a previously imaged plate to a further processing device and then immediately, or soon after, is tilted into it unload position in readiness for unloading the next imaged printing plate. Only unload table proximal segment 294, which is much less heavy and capable of being rotated much faster, is kept clear of rotating imaging drum 210. In the present specification the term “clearance orientation” is used to describe such an orientation of unload table proximal segment 294.

FIG. 4c shows unload table 250 and unload table proximal segment 294 in an orientation in which printing plate 240 is being unloaded from cylindrical surface 220 of imaging drum 210. In the present specification the term “unloading orientation” is used to describe such an orientation of unload table proximal segment 294. To facilitate this unloading, the plate clamps proximate to the proximal end of unload table proximal segment 294 are opened to release a first end of printing plate 240. As a result, the first end of printing plate 240 is raised off cylindrical surface 220 due to the elasticity of the plate. Unload table proximal segment 294 is rotated about unload table proximal segment tilt axis 292 in second unload table proximal segment rotation direction 298 to position the proximal end of unload table proximal segment 294 in an orientation in which it is close to and substantially tangential to cylindrical surface 220. In FIG. 4c unload table proximal segment 294 is shown as being in straight line alignment with unload table 250. This, as explained above in association with FIG. 4b, is but a particular choice. In general, any other orientation advantageous to the unloading of printing plates from imaging drum 210 may be selected for unload table 250, subject to unload table proximal segment 294 being substantially tangential and close to cylindrical surface 220. When imaging drum 210 is subsequently rotated in an imaging drum rotation direction 280 about cylindrical axis 230, printing plate 240 moves onto unload table proximal segment 294 in direction 290, and from there onto unload table 250, or onto a plate punching device ( not shown). To complete the unloading process, the rotation of imaging drum 210 is maintained until a second end of printing plate 240 is proximate the proximal end of unload table proximal segment 294, at which point the clamps holding the second end of printing plate 240 to cylindrical surface 220 are opened and the second end of printing plate 240 is released. A suitable transporting device (not shown) on unload table 250 then moves printing plate 240 further onto unload table 250, or onto the plate punching device, and unload table proximal segment 294 and unload table 250 rotate back about unload table tilt axis 292 and unload table rotation axis 270 respectively to the starting orientation.

When unload table proximal segment 294 is in the unload orientation, the proximity of the proximal end of unload table proximal segment 294 to cylindrical surface 220, as well as the angular deviation of unload table proximal segment 294 from the tangent to surface 220 near the proximal end of unload table proximal segment 294 are both chosen such that printing plate 240 is raised above the surface of unload table proximal segment 294 when printing plate 240 is released as described here.

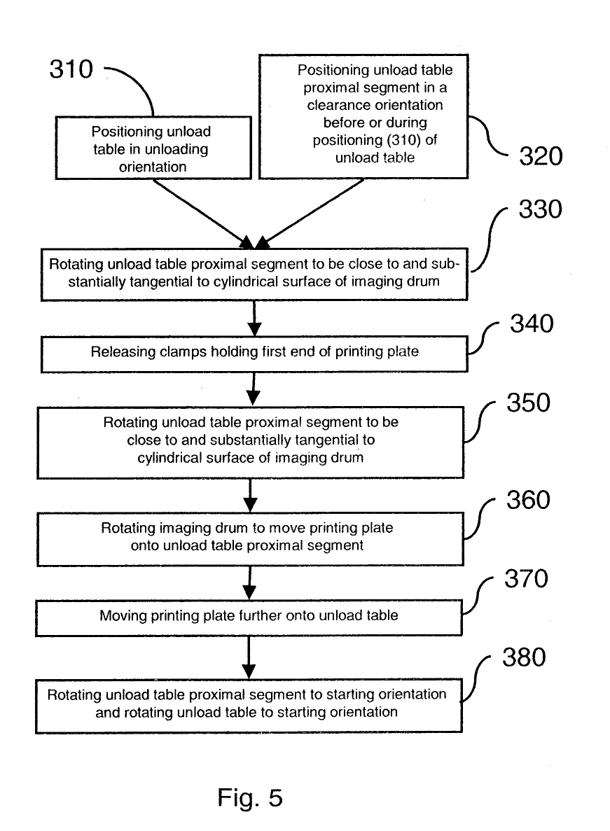

The method of use of this second embodiment of the present invention is described at the hand of FIG. 5 with reference to FIG. 4a, FIG. 4b and FIG. 4c. The method for unloading printing plate 240 from cylindrical surface 220 of imaging drum 210 comprises:
a) positioning (310) unload table in an unloading orientation by rotating unload table 250 about unload table tilting axis 270 in unload tilting direction 260;
b) positioning (320) unload table proximal segment 294, before or during positioning (310) of the unload table, in a clearance orientation;
c) positioning (330) a first end of printing plate 240 proximate unload table proximal segment 294;
d) releasing (340) the clamps holding the first end of printing plate (240) to cylindrical surface 220, the first end of printing plate 240 thereby lifting off cylindrical surface 220 due to its own elasticity;
e) rotating (350) unload table proximal segment 294 around about unload table proximal segment tilt axis 292 in unload table proximal segment rotation direction 260 to position the proximal end of unload table proximal segment 294 in an orientation in which it is close to and substantially tangential to cylindrical surface 220;
f) rotating (360) imaging drum 210 about cylindrical axis 230 to move printing plate 240 onto unload table proximal segment 294 in direction 290 and from there onto unload table 250
g) moving (370) printing plate 240 further onto unload table 250 using a suitable transporting device (not shown) and
h) rotating (380) unload table proximal segment 294 to its starting orientation about unload table proximal segment tilt axis 292 and unload table 250 to its starting orientation about unload table tilt axis 270.

Further operations involving the rotating of imaging drum 210 may be initiated as soon as enough clearance has been established between the proximal end of unload table proximal segment 294 and cylindrical surface 220 of imaging drum 210.

The benefit of this second embodiment of the present invention is that the unload table proximal segment 294 weighs much less than the entire unload table 250. As a result it may be rotated faster, thereby improving throughput as compared with a solution involving the tilting of the entire unload table 50 as per the prior art. It also allows the much heavier and thereby slow-moving unload table 250 to be re-oriented while the imaging drum 210 is engaged in processes other than unloading, thereby improving throughput.

The invention has been described in detail with particular reference to certain preferred embodiments thereof, but it will be understood that variations and modifications can be effected within the scope of the invention.

### PARTS LIST

10 imaging drum
20 cylindrical surface
30 cylindrical axis
40 printing plate
50 unload table
60 unload table rotation direction
70 unload table tilt axis
80 imaging drum rotation direction
90 printing plate unload direction
110 imaging drum
120 cylindrical surface
130 cylindrical axis
140 printing plate
150 unload table
160 unload table proximal segment rotation direction
180 imaging drum rotation direction
190 printing plate unload direction
192 unload table proximal segment tilt axis
194 unload table proximal segment
201 positioning first end of printing plate
202 releasing clamps
203 rotating unload table proximal segment
204 rotating imaging drum
205 moving printing plate
206 rotating unload table proximal segment
210 imaging drum
220 cylindrical surface
230 cylindrical axis
240 printing plate
250 unload table
260 unload table rotation direction
270 unload table tilt axis
280 imaging drum rotation direction
290 printing plate unload direction
292 unload table proximal segment tilt axis
294 unload table proximal segment
296 first unload table proximal segment rotation direction
298 second unload table proximal segment rotation direction
310 positioning unload table
320 positioning unload table proximal segment
330 rotating unload table proximal segment
340 releasing clamps
350 rotating unload table proximal segment
360 rotating imaging drum
370 moving printing plate
380 rotating unload table proximal segment

1. A method for unloading a printing plate from a cylindrical surface of an imaging drum onto an unload table, the unload table comprising an unload table proximal segment, the method comprising:
a) positioning a first end of the printing plate proximate the unload table proximal segment;
b) orienting the unload table proximal segment close to and substantially tangential to the cylindrical surface; and
c) moving the printing plate onto the unload table proximal segment.

2. The method of claim 1, wherein the positioning is by rotating the imaging drum about a cylindrical axis.

3. The method of claim 1, wherein the orienting is by rotating the unload table proximal segment about a first axis in a first direction.

4. The method of claim 1, wherein the moving is by rotating the imaging drum about a cylindrical axis.

5. The method of claim 1, further comprising tilting of the unload table proximal segment to a clearance orientation.

6. The method of claim 5, further comprising tilting of the unload table to an unloading orientation about a second axis.

7. The method of claim 6, wherein the tilting of the unload table proximal segment to a clearance orientation is done before the tilting of the unload table to an unloading orientation.

8. The method of claim 6, the tilting of the unload table proximal segment to a clearance orientation is done during the tilting of the unload table to an unloading orientation.

9. A method for unloading a printing plate from a cylindrical surface of an imaging drum onto an unload table, the unload table comprising an unload table proximal segment, the method comprising tilting of the unload table to an unloading orientation while imaging the printing plate.

10. The method of claim 9, further comprising tilting of the unload table proximal segment to a clearance orientation before or during the tilting of the unload table to an unloading orientation.

11. The method of claim 10, further comprising:
a) positioning a first end of the printing plate proximate the unload table proximal segment;
b) orienting the unload table proximal segment close to and substantially tangential to the cylindrical surface; and
c) moving the printing plate onto the unload table proximal segment.

12. The method of claim 1 1, wherein the positioning is by rotating the imaging drum about a cylindrical axis.

13. The method of claim 11, wherein the orienting is by rotating the unload table proximal segment about a first axis in a first direction.

14. The method of claim 11, wherein the moving is by rotating the imaging drum about a cylindrical axis.

15. An unload table for unloading a printing plate from an imaging drum, the imaging drum having a cylindrical surface and the unload table comprising an unload table proximal segment proximate the cylindrical surface, the unload table proximal segment configured to be oriented close to and substantially tangential to the cylindrical surface by being swiveled with respect to the unload table about a first axis.

16. The unload table of claim 15, wherein the unload table proximal segment is capable of being placed in a clearance orientation.

17. The unload table of claim 16, in which the unload table is configured to be tilted to an unloading orientation about a second axis.

18. The unload table of claim 17, wherein the unload table proximal segment is configured to be tilted to a clearance orientation before the unload table is being tilted to an unloading orientation.

19. The unload table of claim 17, wherein the unload table proximal segment is configured to be tilted to a clearance orientation while the unload table is being tilted to an unloading orientation.

20. An unload table for unloading a printing plate from an imaging drum, the unload table comprising an unload table proximal segment, the unload table capable of being placed in an unloading orientation while the printing plate is being imaged.

21. The unload table of claim 20, wherein the unload table proximal segment is configured to tilt to a clearance orientation before or during tilting of the unload table to an unloading orientation.
